(19) United States
(12) Patent Application Publication
(10) Pub. No.: US 2016/0238391 A1
(43) Pub. Date: Aug. 18, 2016

(54) APPARATUS AND METHOD FOR DRIVING GYRO SENSOR

(71) Applicant: Samsung Electro-Mechanics Co., Ltd., Suwon-si (KR)

(72) Inventors: Jun Kyung NA, Suwon-si (KR); Chang Hee HONG, Suwon-si (KR); Chang Hyun KIM, Suwon-si (KR); Sung Tae KIM, Suwon-si (KR)

(73) Assignee: SAMSUNG ELECTRO-MECHANICS CO., LTD., Suwon-si (KR)

(21) Appl. No.: 14/682,162

(22) Filed: Apr. 9, 2015

(30) Foreign Application Priority Data
Feb. 13, 2015 (KR) 10-2015-0022608

(51) Int. Cl. G01C 19/5776

(52) U.S. Cl. CPC G01C 19/5776

(57) ABSTRACT

There is provided is an apparatus for driving a gyro sensor including: a driving circuit generating a first clock signal based on a driving displacement signal output from the gyro sensor; an oscillator generating a start signal for an initial driving of the gyro sensor; a resonance determiner determining a driving state of the gyro sensor and generating a select signal depending on the determination of the driving state; and a signal transmitter selectively transmitting any one of the first clock signal or the start signal to the driving circuit depending on the select signal, wherein the driving circuit generates a driving signal for driving the gyro sensor based on a transmission signal of the signal transmitter.

### CROSS-REFERENCE TO RELATED APPLICATION

This application claims the benefit of Korean Patent Application No. 10-2015-0022608, filed on Feb. 13, 2015, entitled “Apparatus and Method for Driving Gyro Sensor” which is hereby incorporated by reference in its entirety into this application.

### BACKGROUND

The present disclosure relates to an apparatus and a method for driving a gyro sensor.

Generally, recently developed mobile devices which are equipped with inertial sensors (accelerator sensor, gyro sensor, geomagnetic sensor, or the like) using an inertial input applied from the outside have been released. Among those, the gyro sensor is a sensor which may detect torque quantities of objects to measure an angular velocity of the corresponding object. The angular velocity may be obtained by Corioils force “F=2 mΩV”, in which m represents a mass of a sensor mass, Ω represents an angular velocity to be measured, and V represents a motion velocity of the sensor mass.

FIG. 1 illustrates a principle of detecting an angular velocity of a gyro sensor. When a mass of a sensor resonates in an X direction and a torque is applied in a Z direction, a Corioils force is generated in a Y direction to convert the Corioils force into an electrical signal, the converted signal is subjected to a predetermined signal processing process to detect an inertial force for the angular velocity from a control circuit of the gyro sensor. In this case, to detect a stable inertial input, it is very important to make the mass of the gyro sensor stably resonate at all times.

Further, to make the mass of the gyro sensor stably resonate, a mass resonance amplitude control and a phase control are very important. The mass resonance amplitude control is to control the mass to always resonate in constant amplitude. Further, the phase control is to control a phase difference between a driving signal generated to make the mass resonate and a driving displacement signal generated through the mass to be constantly kept at all times in a control circuit.

### RELATED ART DOCUMENT

### Patent Document

(Patent Document 1) JP2004212111 A

### SUMMARY

An aspect of the present disclosure may make a driving mass of a gyro sensor rapidly resonate and provide an apparatus and a method for driving a gyro sensor capable of being stably driven initially while shortening a time until the gyro sensor in a stop state reaches a resonance state, by applying a driving signal based on a start signal to the driving mass of the gyro sensor through an oscillator and a resonance determiner at the time of initial driving.

According to an aspect of the present disclosure, an apparatus for driving a gyro sensor may include: a driving circuit generating a first clock signal based on a driving displacement signal output from the gyro sensor; an oscillator generating a start signal of which the frequency varies for an initial driving of the gyro sensor; a resonance determiner determining a driving state of the gyro sensor using a frequency or an amplitude of a second clock signal generated based on the driving displacement signal and generating a select signal depending on the determination of the driving state; and a signal transmitter selectively transmitting any one of the first clock signal or the start signal to the driving circuit depending on the select signal, wherein the driving circuit generates a driving signal for driving the gyro sensor based on a transmission signal of the signal transmitter.

According to another aspect of the present disclosure, a method for controlling a gyro sensor may include: transmitting a select signal to a driving circuit through a signal transmitter depending on a control of a select signal selecting the start signal for an initial driving of the gyro sensor; a first clock signal applying a driving signal generated based on an output signal of the signal transmitter to the gyro sensor and generating a first clock signal based on a driving displacement signal output from the gyro sensor; and determining whether a driving of the gyro sensor corresponds to a resonance state using a frequency and an amplitude of a second clock signal generated based on the driving displacement signal and if it is determined that the driving of the gyro sensor corresponds to the resonance state, generating the driving signal based on the first clock signal.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a diagram illustrating a principle of driving a gyro sensor;

FIG. 2 is a graph illustrating an output of the gyro sensor at a resonance frequency point;

FIG. 3 is a block diagram illustrating an apparatus for driving a gyro sensor according to an exemplary embodiment of the present disclosure;

FIG. 4 is a diagram illustrating a process of generating a second clock signal according to an exemplary embodiment of the present disclosure;

FIG. 5 is a circuit diagram illustrating an oscillator according to an exemplary embodiment of the present disclosure;

FIG. 6A is a graph illustrating a relationship between a variable current source and a bias voltage in the exemplary embodiment of the present disclosure and FIG. 6B is a graph illustrating a relationship between a bias voltage and a frequency of a start signal; and

FIG. 7 is a diagram illustrating a method for controlling a gyro sensor according to an exemplary embodiment of the present disclosure.

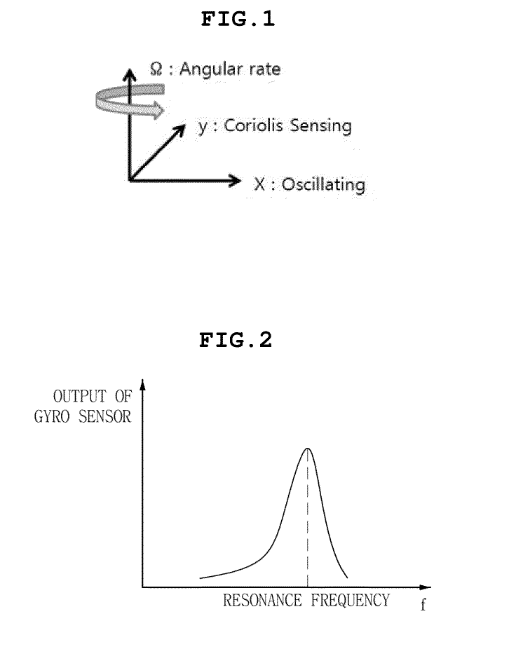

### DETAILED DESCRIPTION

The objects, features and advantages of the present disclosure will be more clearly understood from the following detailed description of the exemplary embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present disclosure, when it is determined that the detailed description of the related art would obscure the gist of the present disclosure, the description thereof will be omitted.

Hereinafter, an exemplary embodiment of the present disclosure will be described in detail with reference to the accompanying drawings, in which a driving displacement signal, and the like may be represented by a voltage form or a current form.

The gyro sensor 10 is a sensor which includes a driving mass (not illustrated) to be able to detect three axial angular velocities which are positioned on a space. There are several types of gyro sensors 10 such as a rotation type gyro sensor, a vibration type gyro sensor, a fluid type gyro sensor, and an optical type gyro sensor. The vibration type gyro sensor has been mainly used in mobile products, recently. The vibration type sensor may be largely divided into two types of a piezoelectric type and a capacitive type.

A driving signal (pulse wave) applied from a driving circuit 100 vibrates a driving mass (not illustrated) of the gyro sensor 10 and a driving displacement signal (sine wave) is generated by the vibration. Here, a resonance condition of the driving mass (not illustrated) by the driving signal is that a phase difference between the driving signal and the driving displacement signal should be 90°.

As illustrated in FIG. 2, even though a size of a driving signal is small, the driving mass (not illustrated) much moves at a resonance frequency of the driving signal applied to the driving mass of the gyro sensor 10, thereby obtaining the driving displacement signal having a large size. Therefore, to obtain a large output from the gyro sensor 10, it is important to make the driving mass rapidly and stably resonate.

Describing in more detail a resonance state, the resonance means a phenomenon that the driving mass vibrates in large amplitude at a specific frequency. In this case, the frequency is referred to as the resonance frequency. When a voltage is applied to two parallel electrodes in the gyro sensor 10, in the case of a piezoelectric scheme, a stress is generated in a piezoelectric material to move an interval between the two electrodes, and in the case of a capacitive scheme, a + charge and a − charge move by a repulsive or attractive force therebetween to move the electrodes.

However, even though a voltage is applied to the electrodes, the driving mass of the gyro sensor 10 does not unconditionally move much but when the frequency of the driving voltage applied to the electrode of the gyro sensor 10 coincides with the frequency of the mass of the gyro sensor 10, the driving mass vibrates and thus the driving of the gyro sensor 10 reaches a resonance state. In this case, the gyro sensor 10 generates a Corioils output, the driving displacement signal from the gyro sensor 10 is converted into a first clock signal via a charge amplifier 110 and a phase shifter 120, and the gyro sensor 10 forms a close loop while the driving signal is applied to the gyro sensor 10.

However, even though the close loop is formed, the gyro sensor 10 does not necessarily resonate. Therefore, a loop which may be resonated is formed only when a signal which may be resonated, that is, a signal which vibrates the driving mass is applied. A circuit including the gyro sensor 10 is not ideal and therefore an offset for each portion is present. Therefore, only when a signal beyond the offset is applied, a resonance loop is formed and a driving of the gyro sensor 10 reaches a resonance state.

The gyro sensor 10 resonates by noise of a circuit or a signal which is generated when a first VDD is applied, but when the offset of the circuit is large, the gyro sensor 10 may not resonate. Further, when a sleep mode in which the gyro sensor 10 is not driven is shifted to an active mode in which the gyro sensor 10 is driven, there may be a case in which much time until the driving of the gyro sensor 10 reaches the resonance state is required.

Accordingly, an apparatus for driving a gyro sensor 10 according to an exemplary embodiment of the present disclosure serves to help the driving of the gyro sensor 10 rapidly and stably reach the resonance state using the driving circuit 100 and the start circuit 200, when the resonance may not be made or much time until the gyro sensor 10 reaches the resonance state is required.

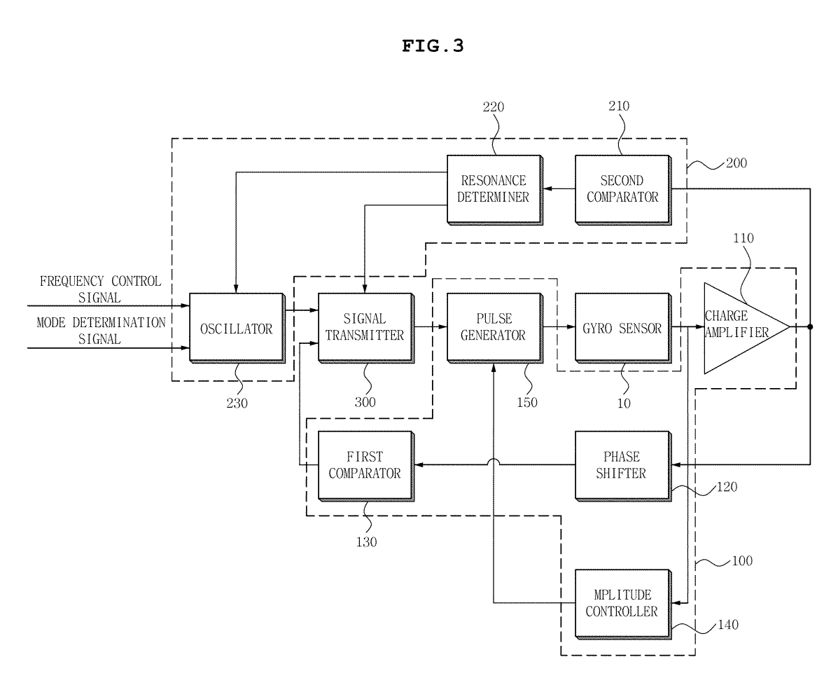

FIG. 3 is a block diagram illustrating an overall system according to an exemplary embodiment of the present disclosure. The apparatus for driving a gyro sensor 10 according to the exemplary embodiment of the present disclosure includes the gyro sensor 10, the driving circuit 100, the start circuit 200, and a signal transmitter 300.

The driving circuit 100 converts the driving displacement signal output from the gyro sensor 10 to generate the first clock signal and generate the driving signal applied to the gyro sensor 10. In detail, the driving circuit 100 converts the driving displacement signal into a voltage signal form and shifts a phase by 90°. The driving circuit 100 uses the 90° shifted driving displacement signal to generate the first clock signal and then transmit the generated first clock signal to the start circuit 200. Next, the driving circuit 100 generates the driving signal based on the frequency of the signal transmitted from the signal transmitter 300 and applies the generated driving signal to the gyro sensor 10. Here, the driving circuit 100 includes the charge amplifier 110, the phase shifter 120, a first comparator 130, an amplitude controller 140, and a pulse generator 150 which will be described below in detail.

The charge amplifier 110 converts the driving displacement signal output from the gyro sensor 10 into a voltage signal form, amplifies the signal, and then transmits the amplified signal to the phase shifter 120 and the start circuit 200. In detail, the charge amplifier 110 converts a change in a charge quantity generated from a driving displacement electrode from the gyro sensor 10 into the voltage signal form and then amplifies the signal.

The phase shifter 120 shifts a phase of an output signal of the charge amplifier 110 by 90°. This is to make the phase difference between the driving displacement signal and the driving signal be 90°, thereby making the driving mass of the gyro sensor 10 stably resonate.

The first comparator 130 compares the output signal of the phase shifter 120 with a reference voltage to generate the first clock signal. In detail, the 90° shifted driving displacement signal is connected to a non-inversion terminal of the first comparator 130 and the reference voltage is connected to an inversion terminal of the first comparator 130. When the 90° shifted driving displacement signal is larger than the reference voltage, the first clock signal in a square wave form having a value of 1 (high) is generated and when the 90° shifted driving displacement signal is smaller than the reference voltage, the first clock signal in the square wave form having a value of 0 (low) is generated. The generated first clock signal is transmitted to the signal transmitter 300.

The amplitude controller 140 determines the amplitude of the driving signal which will be applied to the gyro sensor 10. In detail, the amplitude controller 140 is to always converge the amplitude of the driving signal to a constant value based on the driving displacement signal and determines the amplitude of the driving signal based on an operation using a PID controller, and the like.

The pulse generator 150 selectively receives the first clock signal or the start signal from the signal transmitter 300 to generate the driving signal. The pulse generator 150 generates the driving signal in a pulse wave form having the same period as that of the signal transmitted from the signal transmitter 300 of the start circuit 200 and transmits the generated driving signal to the gyro sensor 10. As described above, the driving signal is used while the driving mass of the gyro sensor 10 resonates.

The start circuit 200 generates the start signal for the initial driving of the gyro sensor 10 and determines the driving state of the gyro sensor 10 based on the driving displacement signal. In detail, the start circuit 200 determines whether the driving of the gyro sensor 10 corresponds to the resonance state and generates a select signal which selects the first clock signal or the start signal.

In more detail, the start circuit 200 converts the driving displacement signal having the voltage signal form which is transmitted from the driving circuit 100 into the second clock signal and then uses the converted second clock signal to determine whether the gyro sensor 10 is in the resonance state. Further, the start circuit 200 generates the select signal depending on the resonance to control the signal transmitter 300. Here, the start circuit 200 includes a second comparator 210, an oscillator 230, and a resonance determiner 220 which will be described below in detail.

The second comparator 210 compares the output signal of the charge amplifier 110 of the driving circuit 100 with the reference voltage to generate the second clock signal. Like generating the first clock signal as described above, when the second comparator 210 compares the driving displacement signal having the voltage signal form with the reference voltage to determine that the driving displacement signal having the voltage signal form is larger than the reference voltage, the second comparator 210 generates the second clock signal in a square wave form having a high value and transmits the generated second clock signal to the resonance determiner 220 and when the second comparator 210 compares the driving displacement signal having the voltage signal form with the reference voltage to determine that the driving displacement signal having the voltage signal form is smaller than the reference voltage, the second comparator 210 generates the second clock signal in the square wave form having a low value and transmits the generated second clock signal to the resonance determiner 220.

The resonance determiner 220 uses the second clock signal to determine whether the gyro sensor 10 resonates. In this case, the resonance determiner 220 uses the second clock signal to determine the resonance of the gyro sensor 10 using various methods.

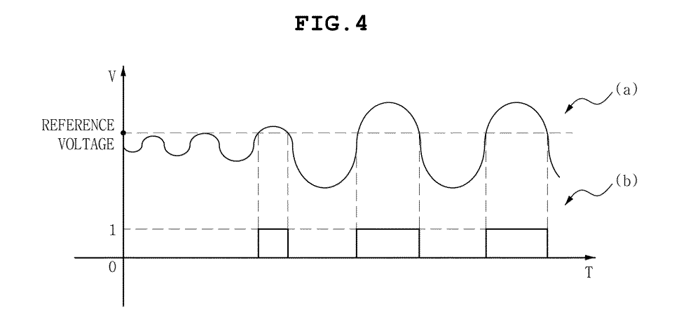

First, when the amplitude of the second clock signal is equal to or more than the preset reference value, it may be determined that the gyro sensor 10 is in the resonance state. FIG. 4 is a diagram illustrating a process of allowing the second comparator 210 to generate the second clock signal, in which FIG. 4A illustrates the driving displacement signal having the voltage signal form and FIG. 4B illustrates that the signal is the second clock signal.

As illustrated in FIGS. 4A and 4B, (a) the signal smaller than the reference voltage is input in the signal initial period, and therefore (b) the second clock signal has a value of 0 (low). However, (a) the square wave signal having a value of 0 (low) and 1 (high) from a point where a period in which (a) the signal is larger than the reference voltage starts is generated. That is, when a period in which (b) the amplitude of the second clock signal has a value of 1 is formed, it may be considered that the driving of the gyro sensor 10 reaches the resonance state. Therefore, the preset reference value may be 1 and when the period in which the amplitude of the second clock signal is equal to or more 1 starts, it may be determined that the gyro sensor 10 resonates. However, the reference value is not necessarily limited to 1 and therefore may be changed by a user to reach another reference value.

There is another method for determining a resonance of a gyro sensor 10 using a frequency of a second clock signal. Another method for determining a resonance of a gyro sensor 10 counts a clock of the second clock signal during a sampling period to measure the frequency of the second clock signal and compares the measured frequency with the preset reference frequency to determine whether the measured frequency is the same as the preset reference frequency. In this case, the preset reference frequency means the resonance frequency which is operated in consideration of each device value and characteristics of the gyro sensor 10 by a user. The frequency may be measured from the generation of the second clock signal and therefore it may be determined whether the gyro sensor 10 rapidly resonates.

If it is determined that the gyro sensor 10 is in an initial driving stage and does not yet reach the resonance state, the resonance determiner 220 guides the driving of the gyro sensor 10 to the resonance state based on the select signal selecting the start signal. If it is determined that the driving of the gyro sensor 10 reaches the resonance state, the close loop is formed and therefore the start signal is no more required. Therefore, the select signal selecting the first clock signal is generated to control the signal transmitter 300.

If it is determined that the driving of the gyro sensor 10 is in the resonance state depending on the control of the select signal, the signal transmitter 300 transmits the first clock signal and if it is determined that the driving of the gyro sensor 10 is in a non-resonance state, the signal transmitter 300 transmits the start signal. That is, any one of the first clock signal or the start signal is transmitted to the pulse generator 150 depending on the select signal of the resonance determiner 220. The signal transmitter 300 may be a switch or a multiplexer (MUX) and any device which may achieve the same purpose may be used.

The oscillator 230 generates the start signal of which the frequency is changed and transmits the generated start signal to the signal transmitter 300. The oscillator 230 means an apparatus which generates an electrical vibration using an electron tube, a semiconductor, and the like. The oscillator 230 includes a signal generator 250 and a frequency controller 240 and the oscillator 230 may be a relaxation oscillator.

The oscillator 230 which is included in the exemplary embodiment of the present disclosure may select a mode which generates an output signal having a fixed oscillation frequency and a mode which generates an output signal having a varying oscillation frequency. The above-mentioned mode is determined by a mode determination signal which is input by an external user.

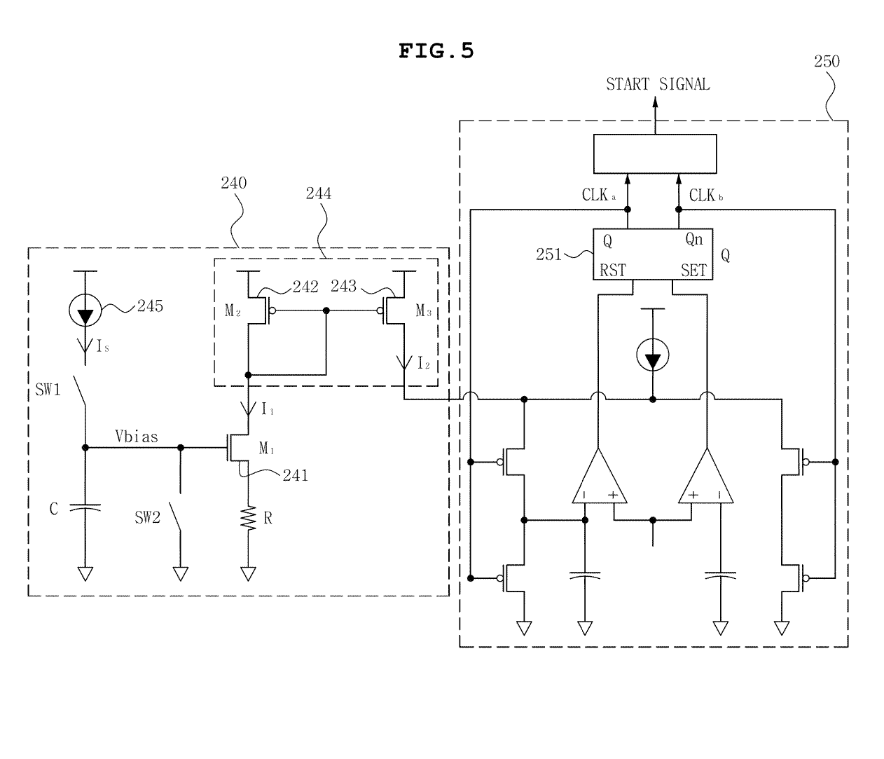

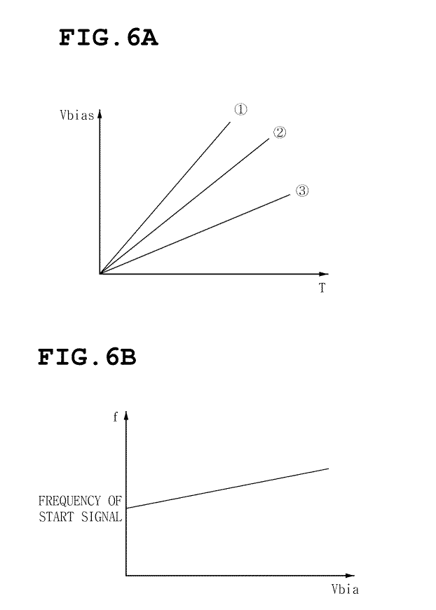

FIG. 5 is a diagram illustrating the oscillator 230 including the signal generator 250 and the frequency controller 240 and FIG. 6A is a graph illustrating a relationship with a bias voltage Vbias according to a control of a variable current source 251 and FIG. 6B is a graph illustrating a relationship between the bias voltage Vbias and the frequency of the start signal.

The signal generator 250 generates the start signal having a frequency lower than the preset reference frequency at the time of the initial driving. The signal generator 250 includes a flip flop 251 and generates a Clk_a clock and a Clk_b clock through a Q terminal and a Qn terminal of the flip flop 251, respectively. The start signal having the square wave form is output based on the subsequently generated Clk_a clock and the Clk_b clock.

The driving signal is generated based on the start signal having a frequency lower than the reference frequency at the time of the initial driving and is applied to the gyro sensor 10. Next, the frequency of the start signal is increased to have a constant slope. When a process of applying the driving signal generated based on the start signal having the constantly increasing frequency is performed, the frequency of the start signal coincides with the resonance frequency at which the gyro sensor 10 resonates. Here, the reference frequency is the same frequency as the reference frequency which is used to determine the resonance.

The frequency controller 240 controls the frequency of the start signal through an input current I₂ of the signal generator 250. The frequency of the start signal is adjusted by the current I₂ which is input to the signal generator 250 through the frequency controller 240 and the frequency of the start signal is constantly increased depending on the change in the input current I₂. The frequency controller 240 includes a first MOSFET 241, a current mirror circuit 244, a variable current source 251, and start switches SW.1 and SW.2.

The first MOSFET 241 controls a current I₁ which flows from a drain to a source based on the bias voltage Vbias applied to a gate. The current mirror circuit 244 makes a magnitude of the current I₁ flowing in the drain equal to that of the input current I₂ of the signal generator 250 and the variable current source 251 adjusts a supply current Is to determine a variation of the bias voltage Vbias. The start switch serves to apply the bias voltage Vbias to the gate of the first MOSFET 241 by the switching operation and includes the first switch SW.1 and the second switch SW.2.

The first switch SW.1 connected to the variable current source 251 is operated in an on state and the second switch SW.2 connected to the gate of the first MOSFET 241 is operated in an off state. In this case, the bias voltage Vbias is formed by the current Is which is supplied from the variable current source 251 and a capacitor C and the bias voltage Vbias is identically applied to the gate of the first MOSFET 241 which is electrically connected to the capacitor C. In this case, the current I₁ starts to flow from the drain of the first MOSFET 241 to the source thereof as the bias voltage Vbias is applied. The same current as the current I₁ flowing in the drain is input to the signal generator 250 by the current mirror circuit 244 which includes the second MOSFET 242 and the third MOSFET 243.

Therefore, when the supply current Is of the variable current source 251 is increased, the bias voltage Vbias is increased. Further, as the bias voltage Vbias is increased, the current I₁ flowing in the drain is also identically increased and the input current I₂ of the signal generator 250 is also increased through the current mirror circuit 244. As the input current I₂ is increased, the frequency of the start signal is increased. When the start signal having the fixed frequency is generated as described above, the start signal is set to constantly output the supply current Is of the variable current source 251.

Like graphs \textcircled{1}, \textcircled{2}, and \textcircled{3} illustrated in FIG. 6A, an increasing amount of the bias voltage Vbias over time is increased, having various slopes depending on the supply current Is of the variable current source 251 In this case, the supply current Is of the variable current source 251 is controlled by a frequency control signal which is input from the outside.

Therefore, like the graph \textcircled{1} illustrated in FIG. 6A, the user performs a control to suddenly increase the frequency of the start signal based on the frequency control signal to shorten the time until the driving of the gyro sensor 10 reaches the resonance state. To the contrary, like the graph \textcircled{1} illustrated in FIG. 6A, the driving of the gyro sensor 10 may stably reach the resonance state by performing a control to smoothly increase the frequency of the start signal.

FIG. 6B illustrates the relationship between the bias voltage and the start signal, which may appreciate that as the bias voltage Vbias is increased, the frequency of the start signal is increased. That is, when the bias voltage Vbias is increased, the input current of the signal generator 250 is increased together and thus the frequency of the start signal is increased, such that the relationship between the bias voltage and the frequency of the start signal corresponds to a proportional relationship. In this case, the initial frequency of the start signal has a value lower than the reference frequency as described above.

Hereinafter, a method for controlling a gyro sensor 10 according to the exemplary embodiment of the present disclosure including the above configuration will be described. Hereinafter, the same or similar content as or to the foregoing content will be omitted or briefly described.

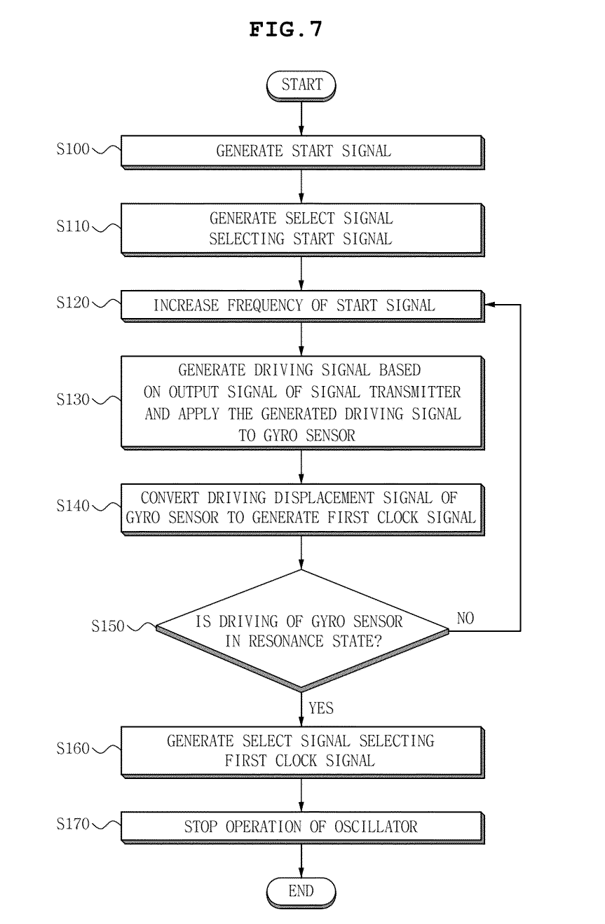

Referring to FIG. 7, in a first step, the start signal for the initial driving of the gyro sensor 10 is generated from the oscillator 230. In detail, the frequency of the start signal is set to have a frequency lower than the preset reference frequency and then the first switch SW.1 of the frequency controller 240 is turned on and the second switch SW.2 is turned off to apply the bias voltage Vbias to the gate of the first MOSFET 241. As the bias voltage is applied to the gate, the start signal is generated from the signal generator 250 (S100) and the generated start signal is transmitted to the signal transmitter 300. Next, as the select signal selecting the start signal is generated (5110), a step of transmitting the start signal to the pulse generator 150 and constantly increasing the frequency of the start signal through the frequency controller 240 is performed (S120).

The step of increasing the frequency of the start signal (S120) will be described in detail. When the supply current Is of the variable current source 251 is increased and thus the bias voltage Vbias applied to the gate of the first MOSFET 241 is increased, as the bias voltage Vbias is increased, the current I₁ flowing in the drain of the first MOSFET 241 is increased. Using the characteristics of the current mirror circuit 244, the input current I₂ of the signal generator 250 is increased like the current I₁ flowing in the drain and therefore the frequency of the start signal output from the signal generator 250 is increased.

Subsequent to the step of increasing the frequency of the start signal, the pulse generator 150 generates the driving signal based on the start signal and applies the generated driving signal to the gyro sensor 10. Then the gyro sensor 10 generated the driving displacement signal.

In more detail, the driving signal is generated according to the frequency of the start signal and the control of the amplitude controller 140 and is applied to the gyro sensor 10 (S130) and the driving displacement signal output from the gyro sensor 10 is converted into the voltage signal form and then is amplified. Next, the phase of the driving displacement signal having the voltage signal form is shifted by 90° and the first comparator 130 compares the 90° shifted driving displacement signal with the reference voltage to generate the first clock signal (S140). As described above, the first clock signal is a clock signal which has a value of 1 in a period larger than the reference voltage and has a value of 0 in a period smaller than the reference voltage.

It is determined whether the gyro sensor 10 resonates using the driving displacement signal after the generation of the first clock signal (S150) and when the gyro sensor 10 resonates, the driving signal is generated based on the driving displacement signal.

In more detail, the second comparator 210 compares the driving displacement signal having the voltage signal form with the reference voltage to generate the second clock signal and then determines whether the driving of the gyro sensor 10 corresponds to the resonance state based on the second clock signal.

As the determination of the resonance, the second clock signal is transmitted from the second comparator 210 and thus the amplitude of the second clock signal is measured and when the amplitude of the second clock signal is equal to or more than the preset reference value, it is determined that the gyro sensor 10 resonates. Here, the reference value may be 1 and to achieve the same purpose, the reference value may have a different value.

Still another method for determining a resonance state includes counting the second clock signal to measure the frequency of the second clock signal and then comparing and determining the frequency of the second clock signal with the preset reference frequency. In this case, the reference frequency means the resonance frequency operated by allowing the user to consider the characteristics and specifications of the gyro sensor 10.

When it is determined that the driving of the gyro sensor 10 corresponds to the resonance state, the select signal selecting the first clock signal is generated (S160). Next, the gyro sensor 10 forms the close loop which generates the driving signal based on the frequency of the first clock signal. Further, the operation of the oscillator 230 stops by the switching operation of turning off the first switch and turning on the second switch (S170).

However, if it is determined that the driving of the gyro sensor 10 is in the non-resonance state, that is, when the amplitude of the second clock signal is less than the reference value or the frequency of the second clock signal is different from the reference frequency, the method returns to a step of increasing the frequency of the start signal and again performs the foregoing steps.

Although the embodiments of the present disclosure have been disclosed for illustrative purposes, it will be appreciated that the present disclosure is not limited thereto, and those skilled in the art will appreciate that various modifications, additions and substitutions are possible, without departing from the scope and spirit of the disclosure.

Accordingly, any and all modifications, variations or equivalent arrangements should be considered to be within the scope of the disclosure, and the detailed scope of the disclosure will be disclosed by the accompanying claims.

What is claimed is:

1. An apparatus for driving a gyro sensor, comprising:
a driving circuit generating a first clock signal based on a driving displacement signal output from the gyro sensor;
a start circuit generating a start signal for an initial driving of the gyro sensor and determining a driving state of the gyro sensor based on the driving displacement signal; and
a signal transmitter selectively transmitting any one of the first clock signal or the start signal to the driving circuit depending on the driving state of the gyro sensor,
wherein the driving circuit generates a driving signal for driving the gyro sensor based on a transmission signal of the signal transmitter.

2. The apparatus of claim 1, wherein the driving circuit includes:
a charge amplifier converting the driving displacement signal output from the gyro sensor into a voltage signal form and then amplifying and outputting the signal;
a phase shifter shifting a phase of the output signal of the charge amplifier;
a first comparator comparing the output signal of the phase shifter with a reference voltage to generate a first clock signal;
an amplitude controller controlling an amplitude of the driving signal to converge the driving of the gyro sensor to a resonance state based on the driving displacement signal; and
a pulse generator selectively receiving the first clock signal or the start signal from the signal transmitter to generate the driving signal.

3. The apparatus of claim 1, wherein the start circuit determines whether the driving of the gyro sensor corresponds to a resonance state based on the driving displacement signal and generates a select signal selecting the first clock signal or the start signal depending on the determination to control the signal transmitter.

4. The apparatus of claim 3, wherein the start circuit includes:
a second comparator comparing the driving displacement signal in a voltage signal form with a reference voltage to generate a second clock signal;
a resonance determiner determining whether the driving of the gyro sensor corresponds to the resonance state using the second clock signal and generating the select signal depending on the determination to control the signal transmitter; and
an oscillator generating the start signal of which a frequency varies and transmitting the generated start signal to the signal transmitter.

5. The apparatus of claim 4, wherein the resonance determiner measures an amplitude of the second clock signal to compare the amplitude of the second clock signal with a preset reference value and determines whether the driving of the gyro sensor corresponds to the resonance state.

6. The apparatus of claim 4, wherein the resonance determiner counts the second clock signal to measure a frequency of the second clock signal and compares the measured frequency of the second clock signal with a preset reference frequency to determine whether the driving of the gyro sensor corresponds to the resonance state.

7. The apparatus of claim 4, wherein the oscillator includes:
a signal generator generating a start signal having a frequency lower than a preset reference frequency at the time of the initial driving; and
a frequency controller controlling the frequency of the start signal to converge the driving of the gyro sensor to the resonance state through an input current of the signal generator.

8. The apparatus of claim 7, wherein the frequency controller includes:
a first MOSFET controlling a current flowing in a drain based on a bias voltage applied to a gate;
a current minor circuit making the current flowing in the drain equal to a magnitude of the input current of the signal generator;
a variable current source adjusting a supply current to determine a variation of the bias voltage; and
a start switch applying the bias voltage to the gate of the first MOSFET by a switching operation.

9. The apparatus of claim 4, wherein the oscillator is a relaxation oscillator.

10. The apparatus of claim 3, wherein the signal transmitter transmits the first clock signal if it is determined that the driving of the gyro sensor is in the resonance state by the select signal and transmits the start signal if it is determined that the driving of the gyro sensor is in a non-resonance state.

11. The apparatus of claim 10, wherein the signal transmitter is a multiplexer (MUX).

12. A method for controlling a gyro sensor, comprising:
a start step of generating a start signal for an initial driving of the gyro sensor and transmitting the generated start signal to a driving circuit through a signal transmitter;
a first clock signal generating step of applying a driving signal generated based on an output signal of the signal transmitter to the gyro sensor and generating a first clock signal based on a driving displacement signal output from the gyro sensor; and
a resonance driving step of determining whether a driving of the gyro sensor corresponds to a resonance state based on the driving displacement signal and if it is determined that the driving of the gyro sensor corresponds to the resonance state, generating a select signal selecting the first clock signal.

13. The method of claim 12, wherein the start step includes:
generating the start signal set to have a frequency lower than a preset reference frequency;
generating the select signal selecting the start signal; and
constantly increasing a frequency of the start signal to allow a frequency controller to converge the driving of the gyro sensor to the resonance state.

14. The method of claim 13, wherein the increasing of the frequency includes:
increasing a supply current of a variable current source to increase a bias voltage applied to a gate of a first MOSFET;
increasing a current flowing in a drain of the first MOSFET depending on an increase in the bias voltage; and
increasing, by a current mirror circuit, an input current of a signal generator to be equal to the increase in the current flowing in the drain to increase the frequency of the start signal.

15. The method of claim 12, wherein the generating of the first clock signal includes:
generating the driving signal based on the output signal of the signal transmitter and applying the generated driving signal to the gyro sensor;
converting the driving displacement signal of the gyro sensor into a voltage signal form and amplifying the signal;
shifting a phase of the driving displacement signal in the voltage signal form; and
comparing the shifted driving displacement signal with a reference voltage to generate the first clock signal.

16. The method of claim 12, wherein the resonance driving step includes:
comparing, by a second comparator, the driving displacement signal in a voltage signal form with a reference voltage to generate a second clock signal;
determining whether the driving of the gyro sensor corresponds to the resonance state using the second clock signal;
if it is determined that the driving of the gyro sensor corresponds to the resonance state, generating the select signal selecting the first clock signal and generating the driving signal based on the first clock signal; and
stopping an operation of an oscillator.

17. The method of claim 16, wherein the resonance determining step includes:
measuring an amplitude of the second clock signal; and
comparing the amplitude of the second clock signal with a preset reference value to determine whether the driving of the gyro sensor corresponds to the resonance state.

18. The method of claim 16, wherein the resonance determining step includes:
counting the second clock signal to measure a frequency of the second clock signal; and
comparing the frequency of the second clock signal with a preset reference frequency to determine whether the driving of the gyro sensor corresponds to the resonance state.
